(19) United States
(12) Patent Application Publication
(10) Pub. No.: US 2014/0032315 A1
(43) Pub. Date: Jan. 30, 2014

(54) SYSTEM AND METHOD FOR MANAGING AN ADVERTISING MARKETPLACE

(71) Applicants: Richard M. Mick Hall, Henderson, NV (US); Jeremy Watkins, Las Vegas, NV (US); Paul Payette, Bethesda, MD (US); Robert Alcantar, Las Vegas, NV (US); Keith Greene, Las Vegas, NV (US)

(72) Inventors: Richard M. Mick Hall, Henderson, NV (US); Jeremy Watkins, Las Vegas, NV (US); Paul Payette, Bethesda, MD (US); Robert Alcantar, Las Vegas, NV (US); Keith Greene, Las Vegas, NV (US)

(73) Assignee: ONSITE CONCIERGE, Henderson, NV (US)

(21) Appl. No.: 13/562,241

(22) Filed: Jul. 30, 2012

(51) Int. Cl. G06Q 30/02

(52) U.S. Cl. 705/14.49; 705/14.72

(57) ABSTRACT

An online system is described that utilizes an extranet or intranet for the selection and purchase of digital advertising media, and the creation, distribution and management of media content. The invention comprises a methodology for presenting an online marketplace that brings together advertisers and media owners with available advertising inventory by providing a dynamic inventory of advertising space that is available for users to display digital advertisements; presenting through one of a plurality of portals a user interface through which a user may build a digital advertisement for use on one or more of the available advertising spaces within the inventory; and causing the created advertisements to be displayed on one or more of the available advertising spaces within the inventory.

### BACKGROUND OF THE INVENTION

Marketing is the process of performing market research, promoting brands, and selling products and/or services to customers, utilizing advertising to further enhance sales. Marketing strategies underlie sales techniques, business communication, and business developments. It is an integrated process through which companies build strong customer relationships and that creates value for their customers and for themselves.

Vendors of goods and services have traditionally invited sales through advertising, the form of which has changed dramatically over the years. Today, a world of possible environments exists in which a vendor can communicate with potential customers about the goods or services available and the advantages of such goods or services. The ability to provide relevant information to the right group of consumers as quickly as possible has been enhanced in the digital age, where consumers have ready access to hand-held electronics and where public postings (e.g., signs and billboards) have become digitized. However, traditional print media and non-digitized billboards remain an important and very viable vehicle for communicating information broadly to potential consumers.

Another part of the marketplace is the advertising media sources; the creators and vendors of advertising space, so to speak. Such sources include publication companies that create newspapers and magazines, bill board companies, network providers, etc. Their goal, of course, is to sell their advertising space to vendors of goods and services, or candidly anyone with a message to publish—i.e., advertisers. An entire industry has developed to bridge the gap between the advertising media sources and the advertisers, brokering the available advertisement space to those who wish to fill the space with advertisements. Indeed, entities exist primarily to represent media sources and advertisers, adding another layer of complexity to the marketing scheme.

While the gap has been bridged fairly well, it can be enhanced greatly, both in the amount of information that can be provided and the speed at which that information can be communicated, translating into more advertisements being created more readily and with more contemporaneous relevance. In other words, there remains a need to more instantaneously identify to advertisers the available inventory of advertising space offered by the media sources, and a need to more readily publish advertisements that are timely and relevant to consumers.

In presenting herein at least some of the solutions to the problems in the marketing art, it should be helpful to have a clear understanding of the definition of certain relevant terms in the discussion. It is the desire to present definitions for terms as they are commonly understood in the marketing art in a broad sense, and not to limit their scope.

Advertising is a form of marketing intended to persuade an audience (viewers, readers or listeners) to purchase or take some action upon products, ideas, or services. It typically includes the name of a product or service and how that product or service could benefit the consumer, to persuade a target market—the relevant consumers—to purchase or to consume that particular brand, or to be impacted by the message conveyed. It is important to keep in mind that not all advertisers have something tangible to sell, but rather desire to communicate an important message to spur some thinking or action. Advertising messages are usually paid for by sponsors and viewed via various advertising media. Advertising can be used in mass media to communicate an idea to a large number of people in an attempt to convince them to take a certain action, or it can be presented in a more focused and targeted manner to a smaller highly relevant audience.

Advertising media is the physical location where the ads appear. Examples include wall paintings, adhesive signs on buildings and sides of buses; billboards; street fixtures such as kiosks, bus stop benches and shelters; taxicab doors, roof mounted signs, interior screens and signs; subway platform signs and those inside trains; printed flyers, rack cards and posters; ads on the backs of event tickets and supermarket receipts; movie trailers and product placements within movies and television shows; television and radio adverts and sponsorships; newspaper display ads, classified ads, and free-standing-inserts (FSI's); magazines; in-flight advertisements on seatback tray tables, overhead storage bins, and sides of airplanes; wall-mounted signs, kiosks, and overhead signs in airports; ads on shopping carts; as well as a variety of new media sources. Any place an “identified” sponsor pays to deliver their message is advertising media. Digital marketing and consumer access to new media have expanded the possibilities of advertising.

New media comprises on-demand access to digital media and advertising media any time, anywhere, on mobile devices, as well as interactive user feedback, creative participation and community formation around the media content. Another important promise of new media is the “democratization” of the creation, publishing, distribution and consumption of media content. New media content is typically digitized into bits. Therefore a dynamic aspect is the digital media creation and distribution, which can be done in real time. New media sources (the physical location where the ads appear) include internet marketing (like blogs, message boards, podcasts, and video sharing), mobile marketing, digital out-of-home media, social media, online magazines, and digital networks.

Mobile marketing comprises using interactive wireless media to provide customers with time and location sensitive, and personalized information that promotes goods, services and ideas. Mobile marketing is also known as wireless marketing. However wireless is not necessarily mobile. For instance, a consumer's communications with a Web site from a desktop computer at home, with signals carried over a wireless local area network (WLAN) or over a satellite network, would qualify as wireless but not mobile communications.

A mobile device (also known as a handheld device, handheld computer or simply handheld) is a pocket-sized computing device, typically having a display screen with touch input and/or a miniature keyboard. Smartphones, tablet PC's such as iPads®, and pdas are popular among those who require the assistance and convenience of certain aspects of a conventional computer, in environments where carrying one would not be practical. A mobile coupon is an electronic ticket or voucher solicited and or delivered mobile phone that can be exchanged for financial discount or rebate when purchasing a product or service. Customarily, coupons are issued by manufacturers of consumer packaged goods or retailers, to be used in retail store as part of sales promotion. They are often distributed through SMS, MMS, WAP, PUSH and other mobile means. The customer redeems the coupon at a store or online.

Digital out-of-home (DOOH) comprises dynamic advertising media distributed across placed-based networks in venues including but not limited to hotels, convention centers, arenas, cafes, bars, restaurants, health clubs, colleges, and other public spaces. DOOH networks typically feature independently addressable video screens, digital billboards, digital street furniture, kiosks, jukeboxes and jumbo-trons. DOOH media benefits location owners and advertisers alike in being able to engage customers and/or audiences and extend the reach and effectiveness of marketing messages. It is also referred to as digital signage.

Needless to say, in the digital age, a certain knowledge of digital computing is helpful to participate in the marketplace. In that regard, certain technical terms are defined consistent with their usage in the technology art supporting of the marketing industry.

An Application Programming Interface (API) is a particular set of rules and specifications that a software program can follow to access and make use of the services and resources provided by another particular software program that implements that API. It serves as an interface between different software programs and facilitates their interaction; similar to the way the graphical user interface facilitates interaction between humans and computers. A graphical user interface (GUI), often phonetically pronounced as gooey, is a type of user interface that allows users to interact with programs in more ways than typing such as computers; hand-held devices such as MP3 players, portable media players or gaming devices; household appliances and office equipment with images rather than text commands. A GUI offers graphical icons, and visual indicators, as opposed to text-based interfaces, typed command labels or text navigation to fully represent the information and actions available to a user. The actions are usually performed through direct manipulation of the graphical elements.

With regard to GUI technology in particular, a modal window is a GUI design that is a child-window requiring users to interact with it before they can return to operating the parent application, thus the workflow of the main window is interrupted. On the web, modal windows are used to draw attention to images or display information in greater detail. Moreover, a widget is an element of a GUI that displays an information arrangement affected by the user, such as a window or a text box. The defining characteristic of a widget is to provide a single interaction point for the direct manipulation of a given kind of data. A radio button is a type of GUI element that allows the user to choose only one of a predefined set of options. They were named after the physical buttons used on older car radios to select preset stations—when one of the buttons was pressed, other buttons would pop out, leaving the pressed button the only button in the “pushed in” position. A slider, also known as track bar in Microsoft® literature, is an object in a GUI with which a user may set a value by moving an indicator, usually in a horizontal fashion. In some cases the user may also click on a point on the slider to change the setting.

In a broad sense, it is presumed that not only those of ordinary skill in the art of digital marketing but also lay persons understand what the internet is. The present invention takes advantage of the internet to solve some of the present marketing problems discussed above by creating a cloud computing marketplace to some degree. Cloud computing is internet-based computing, whereby shared servers provide resources, software, and data to computers and other devices on demand, as with the electricity grid. Cloud computing is a natural evolution of the widespread adoption of virtualization, service-oriented architecture and utility computing. Details are abstracted from consumers, who no longer have need for expertise in, or control over, the technology infrastructure “in the cloud” that supports them. Cloud computing describes a new supplement, consumption, and delivery model for IT services based on the internet, and it typically involves over-the-Internet provision of dynamically scalable and often virtualized resources. It is a byproduct and consequence of the ease-of-access to remote computing sites provided by the Internet. This frequently takes the form of web-based tools or applications that users can access and use through a web browser as if it were a program installed locally on their own computer.

Finally, for purposes of clarification, it is helpful to distinguish the internet from an intranet and an extranet. An intranet is a private computer network that uses internet protocol technologies to securely share any part of an organization's information or network operating system within that organization. The intranet term is used in contrast to internet, a network between organizations, and instead refers to a network within an organization. Sometimes the term refers only to the organization's internal website, but may be a more extensive part of the organization's information technology infrastructure. It may host multiple private websites and constitute an important component and focal point of internal communication and collaboration. While intranets are generally restricted to employees of an organization, extranets may also be accessed by customers, suppliers, or other approved parties. Extranets extend a private network onto the internet with special provisions for access, authorization, and authentication (AAA protocol). Extranets may provide a gateway to the internet by means of a network gateway with a firewall, shielding the intranet from unauthorized external access. The gateway often also implements user authentication, encryption of messages, often via virtual private network (VPN) connectivity, for off-site employees to access company information, computing resources and internal communication.

### SUMMARY OF THE INVENTION

The present invention comprises embodiments that address that need, amongst others. In one respect, an online system that utilizes an extranet or intranet for the selection and purchase of digital advertising media, and the creation, distribution and management of media content is described herein as a methodology for presenting an online marketplace. In some embodiments, the online marketplace system is designed to bring the owners of the digital advertising media and the advertisers together in one digital environment. Indeed, it presents in some embodiments a cloud computing application that provides graphical user interfaces that walk digital advertising media owners through a fairly simple process of digitally uploading inventory into the system online, making open inventory more readily accessible to advertisers to target market consumers. In some embodiments, digital advertising media can be selected and purchased, and advertisements can be produced such that they may be electronically published onto the advertising media (physical location) purchased at any time from any place with access to a computer, tablet PC, or mobile device with Internet or wireless connection.

Among the many benefits of certain embodiments of the present invention, there is an increase in operational efficiencies, a broadening of the market of advertisers, and a reduction in unsold inventory for the advertising media owners, enabling them to sell more advertising media for a lower cost to advertisers. In addition, by automating the process of building ads and managing advertisement campaigns for any form of digital media in real time, even a novice can design national-quality advertisements, eliminating related design and production fees from advertising agencies and graphic design firms. It also requires limited skill to purchase the inventory directly from the source, eliminating the need for professional media buyer and the associated fees and markups.

The present invention is also socially relevant. Embodiments of the invention will create new opportunities for thousands of people that find themselves unemployed by providing tools that eliminate the need for them to become educated in media or advertising in order to enjoy a successful career in advertising sales.

In that respect, in one embodiment, a method is provided for managing digital advertising content for display in one of various media through a graphic user interface accessible remotely, where the method comprises, by way of example, providing a dynamic inventory of advertising space that is available for users to display digital advertisements; presenting through one of a plurality of portals a user interface through which a user may build a digital advertisement for use on one or more of the available advertising spaces within the inventory; and causing the created advertisements to be displayed on one or more of the available advertising spaces within the inventory.

In some embodiments, the method may comprise permitting the user to update the digital advertising as desired by revising content and/or format of the digital advertising, or may comprise storing a plurality of graphic files accessible by the user for purposes of building a digital advertisement. The method may comprise storing a plurality of templates that may be used to facilitate display of digital advertisements on one or more of the available advertising spaces within the inventory, or may further comprise storing relevant data about users and customers of users in a manner so as to enhance the ability of users to target desired customers with relevant created advertisements. In some embodiments, the dynamic inventory may comprise, by way of example, digital billboards, digital publications, and digital networks. In some embodiments, the plurality of portals comprises computers linked to the internet, wherein the plurality of portals may comprise PDA's linked wirelessly to the internet.

### BRIEF DESCRIPTION OF THE DRAWINGS

FIG. 1 illustrates a schematic flow chart of one embodiment of a user graphic interface for advertisers and marketplace affiliates to select advertising inventory.

FIG. 2 illustrates a schematic flow chart of one embodiment of a user graphic interface for advertisers and marketplace affiliates to present information about the end-advertiser.

FIG. 3 illustrates a schematic flow chart of one embodiment of a user graphic interface for advertisers and marketplace affiliates to upload or create advertising graphics.

FIG. 4 illustrates a schematic flow chart of one embodiment of a user graphic interface for advertisers and marketplace affiliates to select an advertisement template from the database of templates associated with the particular advertising inventory selected.

### DETAILED DESCRIPTION OF EMBODIMENTS OF THE INVENTION

The invention comprises in one respect an on-line marketing system accessible and supportive to a large number of participants in the marketplace. Embodiments of the present invention comprise methods or processes that permit various types of entities (users) of the extranet to utilize some or all of the method/process steps, depending upon their particular goals and whether they are buying, selling or reselling digital advertising media. One type of user can be referred to as a digital advertising media owner, or media source, an umbrella group of presenters of advertising through various new-media, for example mobile networks, online magazines, digital out-of-home, digital networks, etc., and may include, for example, advertising agencies that specialize in preparing ads for use by others. Of course, it should be appreciated that non-digital advertising space can also be posted as inventory using the present inventive marketplace system embodiments.

From the perspective of an advertiser, embodiments of the present invention present a methodology in which an advertiser can log-on to the online marketplace system from any device with an internet or wireless connection, (i) select the advertising media (i.e., advertisement space—physical locations) for ads to run from the digital advertising media inventory, either from a visual map by, for example, moving a slider back and forth, increasing or decreasing the size of the geographic radius from the location of their business, or by choosing individual locations by selecting, for example, radio buttons, (ii) create the media content partially or entirely from scratch from a series of widgets in real-time, or import graphics for the advertisement if already developed, and (iii) then publish the advertisement to the selected locations, all in a very short period of time.

Embodiments of the marketplace system herein reduce the barriers to closing the sale by providing all of the digital assets needed to build the media content (the ad) within the application; ads can be changed or updated at any time simply and easily, keeping ads on the network more relevant and timely than other forms of advertising media, increasing the value and overall length of the campaign; by using the online marketplace system, organizations selling digital advertising media will be able to maximize their sales efforts by easily cross-selling other digital media offered on the application.

The present invention should serve to expand the market to include local businesses that have not advertised in the past due to the high-cost of digital media content creation and the complexity of this form of advertising, a surprising circumstance evidenced by a statistic that represents that only 8% of the 27.5 million small businesses in the US have used Google® AdWords® due to the confusion on how to bid and place advertising on the system; and that utilizing the marketplace system, hotels, convention centers, malls, and other venues can sell their own media to advertisers using embodiments of the present inventive system because they no longer have to be experts, nor do they have to collect the digital assets needed to run the ads.

From the perspective of a media source, advertising media can be placed into inventory using the inventive on-line marketing system, after which it can be purchased by an advertiser for media content to be created and the advertisement to be published. The marketing system can be designed to permit a media source to identify and post inventory even from a mobile device, such as mobile phone, tablet PC, a PDA, or an iPad®. Inventory can be added on an as-available basis, allowing for the quick sale of unsold ads through the application; when implemented appropriately, certain embodiments of the system can collect and distribute all monies to the appropriate sales organizations and/or individuals, making sure that there is no breakage in collection of funds.

Certain embodiments of the present invention present an automated third party sales process of selling digital advertising to clients, whereby agents, agencies and advertising media resellers can increase overall efficiencies while reducing the need to have highly knowledgeable, and highly-compensated salespeople selling this complex medium to the end-users of the advertising media. It is contemplated, however, that such embodiments, or other embodiments could still present an automated purchase process whereby advertisers have the ability to log onto the online marketplace and buy media with or without the assistance of a media buyer, agent, agency or media salesperson.

In one embodiment of the invention, the marketplace system may be created, operated and maintained by an entity other than the participants in the market (such as the advertisers, media sources, etc.), where those participants would have access to the marketplace system in the form of an extranet. However, advantageously, embodiments of the present invention permit media owners to operate and maintain the marketplace system themselves, such as in the form of an intranet. One step in an embodiment of the process applicable to an advertising media owner desiring to post inventory comprises inviting such owner to decide whether to make the advertising media inventory available to the marketplace system which manages the inventory and the relationship with this third party sales force or to utilize the system as an internal sales tool via their own intranet, whereby only their direct sales force would have access to the inventory.

Another step in one embodiment comprises inviting advertising media owners to decide whether to make the digital advertising media available real-time via application programming interface (API), or to upload blocks of inventory on an as-needed basis. Online travel agencies such as Travelocity effectively demonstrate similar systems of inventory aggregation and management, playing an important role in filling, unsold hotel rooms, selling unsold airline tickets and booking car rentals around the world. The database of inventory may be configured so that the inventory may be stored and/or accessed by numerous categories, such as digital (versus non-digital), owner, type (magazine, billboard), subscription, etc.

Once these two preliminary decisions are made, the advertising media owners can utilize aspects of the present invention that comprise self-guided process steps for signing-up and uploading information on the available digital advertising media inventory, as well as uploading advertisement templates into the system, which enable the advertisers to easily build the advertising media specifically for the desired media space in the inventory. If the advertising media owner does not possess pre-built advertisement templates, that service may also be provided in an embodiment of the inventive marketplace system.

As described above, embodiments of the present invention permits advertising media owners to place inventory into the system for sale to advertisers by their direct sales force, and/or for sale by the marketplace, acting as their third party sales force. Embodiments of the marketplace process also permit other entities and individuals to register as marketplace affiliates to sell the advertising inventory posted on the marketplace to advertisers and, thereby, collect commissions or other forms of remuneration. Such marketplace affiliates could include, for example, media sales organizations, sales representatives, university students, trade organizations, professional organizations, and non-profit organizations that want to utilize the marketplace methodology. The system, in essence, provides a vehicle in which others may participate economically in the market.

In one example, a marketplace affiliate could designating other individuals or organizations as subsidiary marketplace affiliates, whereby they can build a media sales organization with multiple tiers of commissions (or other incentives) paid automatically by the system. Still other embodiments include the system being integrated with the existing protocols established by the massive online affiliate sales networks, making this a great new product for multi-level sales, telemarketing sales firms, and online marketing firms, who are skilled at database marketing and direct marketing.

As with advertising media owners, in embodiments of the invention, marketplace affiliates could proceed through a relatively quick sign-up process, as part of a preliminary step. The second step of the system may comprise issuing the user a unique identification number, which tracks their sales and provides them sign-in access to all of the marketplace sales tools, all of which are made immediately available. The marketplace affiliates can then use the marketplace tools on behalf of the advertisers to select digital advertising media and build the media content, or the advertiser can go through the process themselves, and as long as they enter the marketplace affiliate's identification number when prompted, that individual or organization, as well as any subsidiary marketplace affiliates could receive commission for the sale.

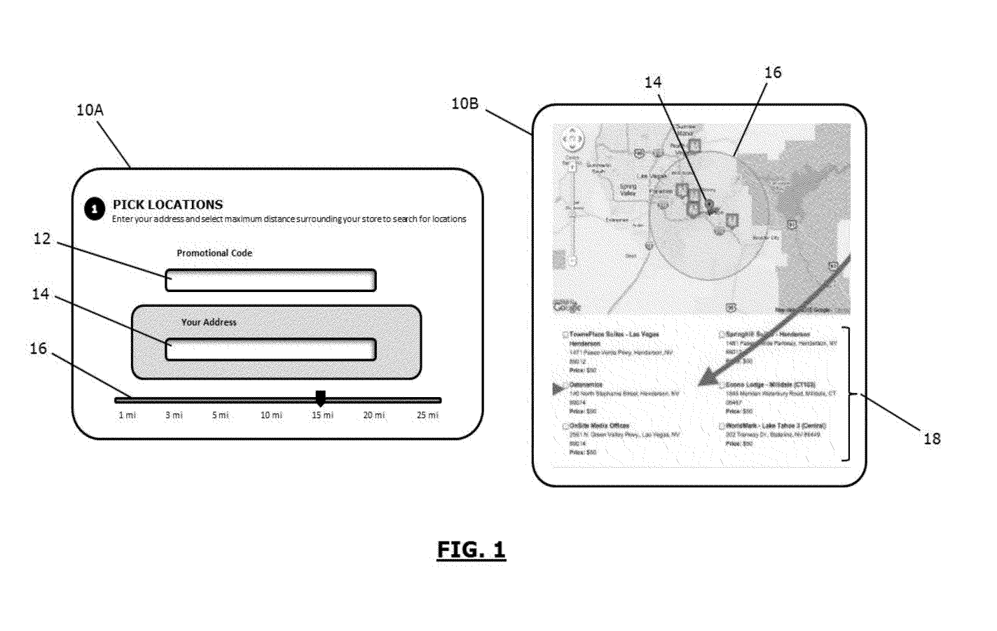

In one embodiment of the invention, advertisers or marketplace affiliates select digital advertising media from the available inventory of new-media (for example mobile networks, online magazines, digital out-of-home, digital networks, etc.) within the online marketplace, utilizing a series of graphical user interfaces and data entry fields. Referring to FIG. 1, by way of example only, the user may select the type of media that they are interested in purchasing, after which they are presented with three steps to be follow in which information is to be provided. In the example shown in FIG. 1, a first window 10A may be presented by which a user may proceed to select, for example, digital out-of-home media. Of course, as with all of the steps in the process, the graphic user interface may vary markedly depending upon the aesthetics and experience desired, including the type of information necessary to process the request and/or to proceed to the next step.

In the embodiment of FIG. 1, a user (e.g., retailer at a particular location desiring to purchase advertising space with a certain geographical region surrounding the location) may be asked in window 10A to enter a promotional code 12, that may also serve as an affiliate code or the like that automatically credits the sale to the appropriate salesperson and sale organization where such information is meaningful for such person or organization tasked with promoting the inventory to users. The user may also be promoted to enter the physical address 14 of the end-advertiser (the entity originating the message to be published). an address 14, and then to choose from one of a plurality of distances 16 (e.g., radius in miles) from the location address within which the user desires available advertising space. Utilizing, for example, a slider, the user is able to select different radius sizes for their search, which will alter the breadth of the search and ultimately the locations displayed on a visual map within the user interface. In this embodiment of a marketplace system methodology of the present invention, upon entering the address, the system initiates a back-end data look-up. In a separate window 10B, a map and data reflecting available digital advertising media inventory 18 within such selected distance 16 of such address location 14 may be displayed, with sufficient information to permit the user to select one or more desired available advertising spaces from the inventory. From the list and locations on the map provided by the query, the user then selects the locations in which they wish to purchase, for example, digital out-of-home advertising media by checking, for example, radio buttons.

Once the user indicates they are ready to move on to the next step of the process, the system validates all of the information entered and queried on the page and either announces that the user must correct any invalid field data before continuing, or automatically advances the user to the next step of the process.

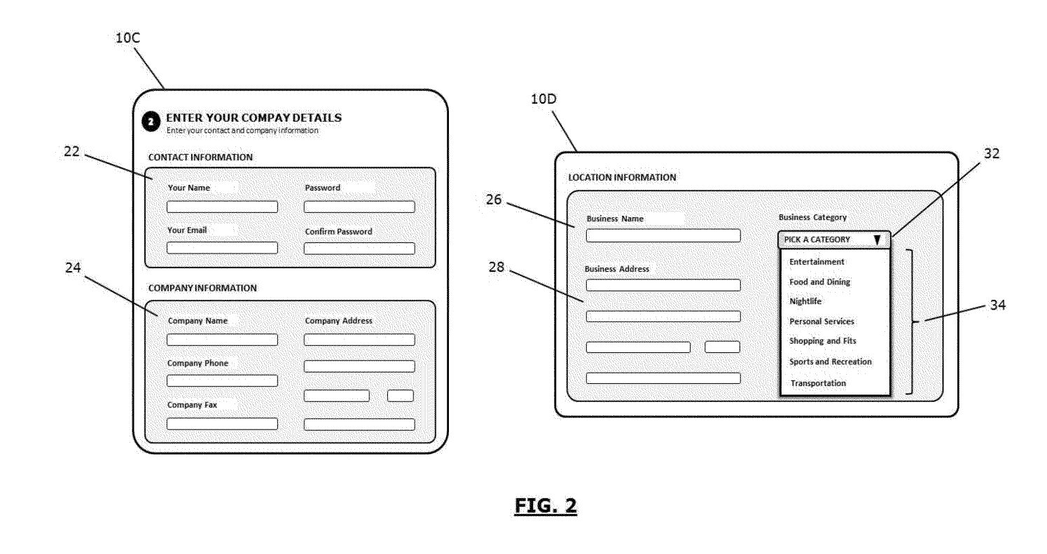

Referring to FIG. 2, the possible second step of one embodiment of the process comprises collecting the end-advertiser's company information, business information, and business category. A window 10C by example may be presented permitting the user to enter the advertiser's contact information 22, for example a company representative or agent, including information such as email address and password if appropriate. In the addition, window 10C may permit input of company information 24, such as the company name (as they might desire it to appear on the advertisement) and its main address. Where desired, and certainly to accommodate companies that have, for example, a headquarters and separate business locations, a second window 10D may be provided permitting the user to input the business name 26, if different, the business address 28, if different from company address, and to, optionally select from one of a plurality of categories 32 that briefly identify the nature of the business 34, such as entertainment, food and dining, etc. The categories may be provided in a pull-down menu or by other graphic means. Preferably, the data provided by the user's representative or agent is stored in a database accessible by the network provider to ensure efficient and effective service to the users, and to permit a user/retailer to modify its account information and its desired advertising campaign at any time in the future.

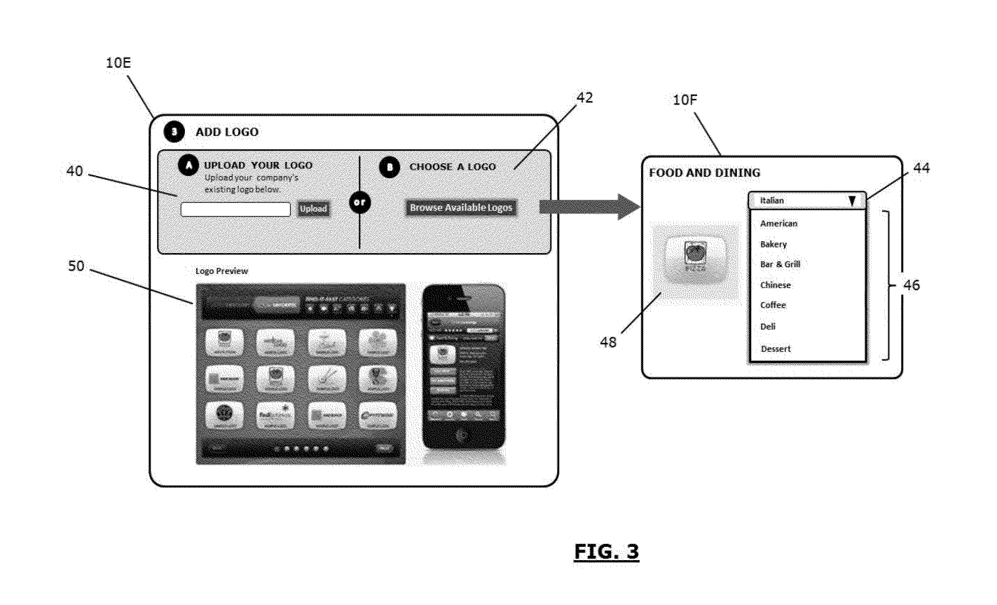

Referring to FIG. 3, the user may then be presented with a graphical user interface 10E allowing them to either upload a logo of their own at 40, which will be automatically placed into the correct location within the advertisement, or select a logo 42 from a database of previously-created logos provided by the advertising media owners. If the user chooses to select a logo from the database, a new interface 10F could be presented to them that comprises a pull-down menu 44 containing sub-categories 46 based on the advertiser's business sector identified in the previous step of the process (as an example, if the advertiser's business sector is Restaurant, their sub-categories could include different ethnic restaurant categories, such as Italian, Chinese, Mexican, etc). Once a sub-category has been chose, the available logos within that sub-category could be displayed, for example logo 48. After selecting a logo, it would be preferably placed into the correct location within the advertisement in a logo preview display 50.

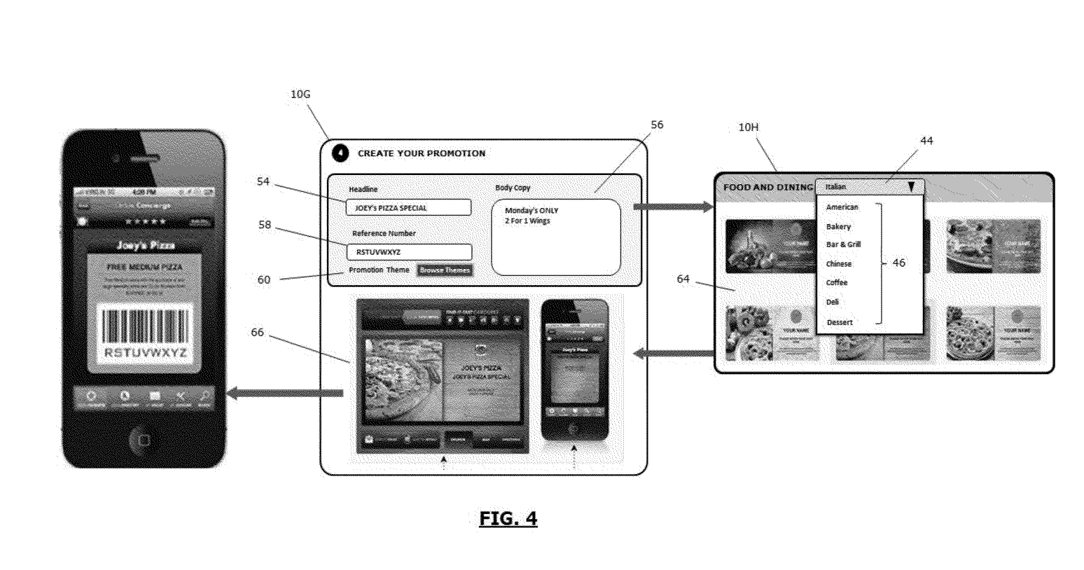

Next, referring to FIG. 4, the user may be prompted at a graphic interface window 10G to enter the information relevant to the advertisement, including a headline 54, advertisement body copy, 56 and optionally other information, such as a reference number 58 or tracking code displayable on the ad, making the administration of the redemption process easier, should the advertiser be creating a discount. Once the advertisement information has been entered, the user is preferably presented with a choice of promotion themes 60 that links to a graphic interface window 10H from which the user may select from one of a plurality of advertisement template 64 from the database of templates provided by the advertising media owners in a similar fashion to the way they selected the logo from the database in the above step. An menu is preferably presented to the advertiser allowing them to choose business sub-categories 46 based on the business sector they selected previously. When a sub-category is chosen, the advertiser is presented with the available advertisement templates from within that sub-category. Once the user selects an advertisement template, they are presented with a preview of the final advertisement 66 in one form or another, which may appear on the previous window 10G. This preview preferably comprises the template they selected, the logo they selected, as well as the relevant advertisement information.

Advantageously, if the advertiser updates any of the advertisement information (headline, body copy, etc.), the preview is also updated. Once the user indicates they are ready to move on to the next step of the process, the system validates all of the information entered on the page and either announces that the user must correct any invalid field data before continuing, or automatically advances the user to the next step of the process. The advertiser beneficially may see the advertisement they are creating in real time as they create the promotion. If desired, the system may automatically generate promotion bar codes at the advertiser's request, so that the resulting advertisement might look, for example, by what is shown on a customer's mobile device 66 in FIG. 4. In one embodiment, an optional feature comprises an auto-generated map reflecting the advertiser's location that may also be presented to a potential customer.

During another step of the process, the user is preferably given an opportunity to present payment information they will use to pay for the advertisement they have just created. If the user wishes to edit any of the information previously entered, they are able to return to the previous steps at any time. Once they indicate that they are ready to order the advertisement, one embodiment of the system may validate their information and announce that the user must correct any invalid field data before their application can be processed.

Upon successful submission, the system preferably creates the necessary database entries for their account and indicates that the advertisement must go through an approval process before publishing/distributing the ad(s). The user is sent a confirmation email detailing their transaction. Once an advertisement has been approved and is distributed to the live system, a consumer can encounter the advertisement in multiple ways. First, in one embodiment, a consumer may encounter an advertisement at one of the locations selected and paid for by the advertiser, at which they might be shown the advertisement while accessing the internet on a digital network from inside that location. The consumer is preferably able to send the advertisement to their email or mobile device through an interface available to them at that location.

If desired, in one embodiment, the consumer is also able to download an advertisement via a mobile application to their mobile device and send the advertisement to a folder within that application. The user is then able to view advertisements through their mobile device directly should they be near the advertiser's general area, regardless of whether they have had a prior encounter with the advertisement on a digital network or not. The consumer is able to send the advertisement to their email or save it within their mobile device through the interface available to them, as well as download the mobile application. Once the advertisement is on the mobile device, the consumer is able to redeem any discounts associated with an advertisement. Utilizing GPS technology, the mobile application identifies the consumer's current location, and upon redeeming a coupon, the mobile application contacts the online marketplace back-end system and records that the discount has been redeemed.

It should be appreciated that numerous other embodiments are contemplated by the present invention, which is reflected more broadly by the claims below. Each of the steps above may be utilized in combination, or may be selectively provided, either by the system administrator/creator, or by the user/advertiser/consumer. The visual graphics, including graphic interfaces, are of course presented by way of examples only. The embodiments described herein are presented to give exemplary illustrations of various ways in which the marketplace system methodology may be put into place and accessed. For example, all of the information contemplated by one or more of the embodiments described above may be stored in a single location for remote access as so desired. Alternatively, portions of the information may be stored in different locations depending upon which party in the marketplace uploads such information or desired access to such information. Thus, it is contemplated that the methodology may be presented in an all-in-one package, such as firmware providing memory for storing databases of inventory, graphics and templates, or as software that permits the user to take advantage of the inventive methodology without having to store all of the inventory, graphics and templates. That is why the present invention has intranet and extranet applications, and presents a cloud computing application where so desired.

What is claimed is:

1. A method for managing digital advertising content for display in one of various media through a graphic user interface accessible remotely, the method comprising:
providing a dynamic inventory of advertising space that is available for users to display digital advertisements;
presenting through one of a plurality of portals a user interface through which a user may build a digital advertisement for use on one or more of the available advertising spaces within the inventory; and
causing the created advertisements to be displayed on one or more of the available advertising spaces within the inventory.

2. The method of claim 1, further comprising permitting the user to update the digital advertising as desired by revising content and/or format of the digital advertising.

3. The method of claim 1, further comprising storing a plurality of graphic files accessible by the user for purposes of building a digital advertisement.

4. The method of claim 1, further comprising storing a plurality of templates that may be used to facilitate display of digital advertisements on one or more of the available advertising spaces within the inventory.

5. The method of claim 1, further comprising storing relevant data about users and customers of users in a manner so as to enhance the ability of users to target desired customers with relevant created advertisements.

6. The method of claim 1, wherein the dynamic inventory comprises digital billboards.

7. The method of claim 1, wherein the dynamic inventory comprises digital publications.

8. The method of claim 1, wherein the dynamic inventory comprises digital networks.

9. The method of claim 1, wherein the plurality of portals comprises computers linked to the internet.

10. The method of claim 1, wherein the plurality of portals comprises PDA's linked wirelessly to the internet.
